(19) United States
(12) Patent Application Publication
(10) Pub. No.: US 2011/0114644 A1
(43) Pub. Date: May 19, 2011

(54) PRESSURE RELEASE BUTTON AND TOOL FOR PROPANE CYLINDERS

(75) Inventor: John Richard Willey, Derby, KS (US)

(73) Assignee: THE COLEMAN COMPANY, INC., Wichita, KS (US)

(21) Appl. No.: 12/594,850

(22) PCT Filed: Jan. 20, 2008
(86) PCT No.: PCT/US2008/052519

§ 371 Date: Jan. 14, 2011

Related U.S. Application Data
(60) Provisional application No. 60/887,267, filed on Jan. 30, 2007.
(60) Provisional application No. 60/942,369, filed on Jun. 6, 2007.

(51) Int. Cl. F17C 13/00; F17C 1/00; F17C 13/06

(52) U.S. Cl. 220/581; 220/89.1; 220/203.07; 220/735

(57) ABSTRACT

A recycling button (20) and recycling tool (150) for releasing propane from a propane cylinder (10). The recycling button (20) includes a barb (42) or other means that secures the recycling button (20) to the propane cylinder (10), thereby keeping the valve (16) of the propane cylinder (10) in an open position. The recycling button (20) is configured so that propane gas may exit the propane cylinder (10) to the atmosphere or a recycling tool (150). The recycling tool (150) aids in using a recycling button (20) and includes a diaphragm (160) attached to an indicator (162) so that any pressure exiting the propane cylinder (10) causes the diaphragm (160) to expand and the indicator (162) to show, thereby alerting users that there is still pressure inside the propane cylinder (10).

### REFERENCE TO RELATED APPLICATIONS

This application claims priority to U.S. provisional patent application Ser. No. 60/887,267, filed Jan. 30, 2007 and U.S. provisional patent application Ser. No. 60/942,369, filed Jun. 6, 2007, both of which are incorporated herein by reference.

### BACKGROUND OF THE INVENTION

Propane is used for a variety of outdoor fuel burning appliances. As examples, many users own grills, lanterns, stoves, and many other appliances that may be used in an outdoor environment and that utilize propane as a fuel source.

For many home applications, a homeowner may use a twenty pound propane cylinder to supply propane to an outdoor fuel burning appliance. These cylinders may be easily refilled or exchanged at many hardware or convenience stores.

When tailgating or camping, a user often does not want to transport a large twenty pound propane cylinder. More often, the user will use disposable 16.4 or 14.1 fluid ounce propane cylinders, such as the well-known green cylinders marketed by The Coleman Company, Inc., assignee of the present invention.

The disposable propane cylinders are generally made of recyclable materials such as metal. However, propane cylinders are often discarded as trash because recyclers often refuse to recycle propane cylinders because there is no effective way to ensure that propane cylinders are empty. Moreover, laws and regulations often prohibit refilling the disposable propane cylinders. Consequently, millions of propane cylinders end up in landfills every year and many pounds of recyclable materials are wasted.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description of some embodiments that are presented later.

In accordance with an embodiment, a propane recycling button is provided. The recycling button includes a head and a nipple, the nipple having a barb. The recycling button is arranged and configured to be inserted into the opening in the neck of a propane cylinder. When inserted, the recycling button releases pressure and propane inside the propane cylinder, and the presence of the recycling button serves as a positive visual indicator that the propane cylinder is empty.

When the recycling button is inserted in the neck of a propane cylinder, the nipple of the recycling button opens a valve inside the cylinder, releasing the pressure inside. Propane released from the propane cylinder passes through or around the recycling button. The barb of the nipple causes the recycling button to remain attached within the neck of the propane cylinder, thereby keeping the valve open and allowing the pressure inside the cylinder to equalize with pressure outside the cylinder (i.e., atmosphere).

In accordance with an embodiment, a tool for inserting the recycling button may be included. The tool includes a casing, a diaphragm, and an indicator. In use, a recycling button is placed into the tool and the tool is then placed onto the propane cylinder, for example on the neck of a propane cylinder. The tool aids in inserting the recycling button into the neck of the propane cylinder. If there is propane in the propane cylinder under a pressure greater than outside atmospheric pressure, gas will escape from the propane cylinder, forcing the diaphragm of the tool to expand and causing the indicator to display. Gas exits the recycling tool through a port in the tool. When there is no pressure inside the propane cylinder, the indicator no longer displays, thereby alerting users that a propane cylinder is empty. The tool may then be removed, with the recycling button serving as a positive visual indicator that the propane cylinder has been emptied.

Although the tool may be used to install a recycling button, the recycling button may be placed into the cylinder without using a recycling button tool.

In accordance with an embodiment, the recycling button may be stored in a cap for the propane cylinder. In an embodiment, the cap may include a structure for preventing accidental insertion of the plug upon dropping of the cylinder when the button is stored in the cap and the cap is mounted on the cylinder. In another embodiment, the nipple may be arranged to extend upward, so that dropping of the propane cylinder cannot result in insertion of the nipple into the mouth of the propane cylinder.

In accordance with another embodiment, a tool for releasing pressurized contents of a container via a pressure-release valve is provided. The tool includes a bar having two parallel prongs extending from an end of the bar, each prong bent so as to form two parallel feet, the feet configured to fit inside an opening containing the pressure-release valve. The tool also includes a first slot extending through the feet and configured to engage a plunger of the pressure-release valve behind a head or at a swedge of the pressure-release valve. The tool includes a second slot extending between the two parallel prongs, continuous with the first slot, and having a width approximately equal to a width of the first slot, the second slot having a length greater than a radius of the opening.

In accordance with another embodiment, a tool for releasing pressurized contents of a butane-style fuel container is provided. The tool includes a cylinder having a cylindrical wall substantially closed by a disk on a first end and having an interior surface, the cylinder having a second end opposite the disk. The recycling button also includes a shaft extending inwardly from a center of the disk, and an interior thread extending around the interior surface and corresponding to an exterior thread on a butane-style fuel container.

Other features of the invention will become apparent from the following detailed description when taken in conjunction with the drawings, in which:

### BRIEF DESCRIPTION OF THE DRAWINGS

FIG. 1 is a section view of a recycling tool attached to a propane cylinder and configured to be used with a recycling button, in accordance with an embodiment;

FIG. 2 is a side view of the recycling button of FIG. 1;

FIG. 3 is a bottom view of the recycling button of FIG. 1;

FIG. 4 is a side view of an alternate embodiment of a recycling button;

FIG. 5 is a bottom view of the recycling button of FIG. 4;

FIG. 6 is a top, side perspective view of a recycling button mounted inside a cap in accordance with an embodiment;

FIG. 7 is a bottom perspective view of the cap of FIG. 6;

FIG. 8 is a top perspective view of the cap of FIG. 6 with the recycling button removed;

FIG. 9 is a top, side perspective view of a cap for receiving a recycling button in accordance with another embodiment;

FIG. 10 is a bottom perspective view of the cap and recycling button of FIG. 9;

FIG. 11 is a bottom perspective view of the cap of FIG. 10, with the recycling button removed;

FIG. 12 is a side perspective view of the cap of FIG. 10, with the recycling button removed by a shaft from a connector from a propane-utilizing appliance;

FIG. 13 is a side cutaway view of a pressure-relief valve of a propane cylinder;

FIG. 14 is a side perspective view of a tool for releasing the contents of the propane cylinder of FIG. 13 via the pressure-relief valve;

FIG. 15 is a top view of the tool of FIG. 14;

FIG. 16 is a side view of the tool of FIG. 14;

FIG. 17 is a side perspective view of the tool of FIG. 14 being used to release the contents of a propane cylinder;

FIG. 18 is a side cutaway view taken along the section lines 18-18 with the pressure-release valve having a head;

FIG. 19 is a side cutaway view of the tool of FIG. 14 being used to release the contents of a propane cylinder, the release valve of which has a swedge;

FIG. 20 is a side sectional view of the tool and propane cylinder of FIG. 19;

FIG. 21 is a side sectional view of the tool of FIG. 14 secured over the pressure-release valve while maintaining the pressure-release valve in an open configuration;

FIG. 22 is a bottom perspective view of a recycling button in accordance with an alternate embodiment;

FIG. 23 is a top perspective view of the recycling button of FIG. 22;

FIG. 24 is a side view of the recycling button of FIG. 22;

FIG. 25 is a side perspective view of the recycling button of FIG. 22 being used to release the contents of a butane cylinder; and

FIG. 26 is a partial sectional view of another embodiment of a recycling button.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

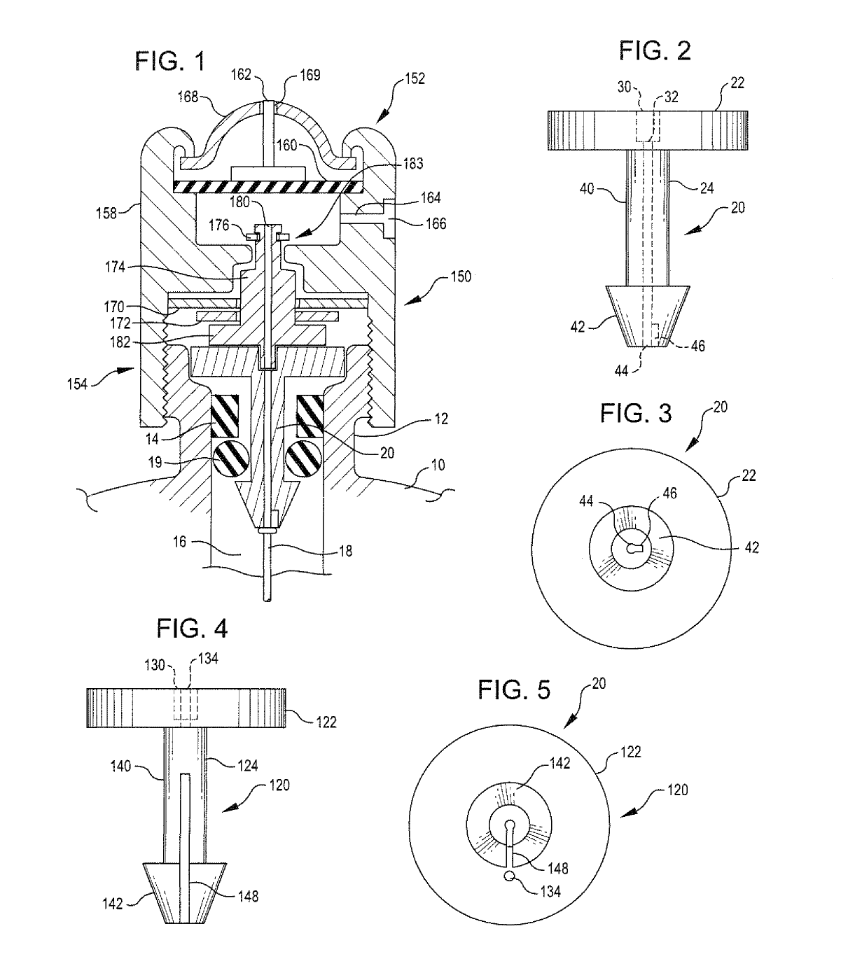

Referring now to the drawings, in which like reference numerals represent like parts throughout the several views, FIG. 1 shows a top, neck portion of a typical disposable propane cylinder 10. As characteristic of propane cylinders, the propane cylinder 10 includes a threaded neck 12 providing an opening into the propane cylinder. The neck 12 is configured for attachment to appliances, such as camp stoves or lanterns, which utilize propane.

An o-ring retainer 14 and an o-ring 19 sit inside the neck 12 and provide a seal between the propane cylinder 10 and appliances that are attached to the propane cylinder 10. The valve 16 sits inside the propane cylinder 10 and includes a valve core 18. As is known, when the valve core 18 is pressed downward into the valve 16, the valve 16 opens and gasses may pass through the valve 16 from the propane cylinder 10.

In accordance with an embodiment, a recycling button is provided for propane cylinders, such as the propane cylinder 10. In general, a recycling button may be any device that is configured to hold the valve 16 of a propane cylinder 10 open and keep the valve 16 open after insertion. In an embodiment, the recycling button is configured so that when the valve 16 is open, propane is allowed to be released from the propane cylinder 10 into the atmosphere. The recycling button may be configured so that it is difficult for a user to remove, as described below.

FIG. 2 shows a recycling button 20 in accordance with an embodiment. The recycling button 20 includes a head 22 and a nipple 24 and may be configured from plastic, metal, or other suitable materials.

In general, the head 22 is designed to aid in insertion of the recycling button 20 into a neck of a propane cylinder (e.g., the neck 12 of the propane cylinder 10). The head 22 may also be shaped to be received within the neck 12, so that when the recycling button 20 is installed, the top of the head 22 extends flat with the top of the neck. In an embodiment, the diameter of the head 22 is wider than the nipple 24 to provide a flat surface for pushing the recycling button 20 into a propane cylinder 10. However, the head 22 may be smaller or the same diameter as the nipple 24.

In the embodiment shown in the drawings, the head 22 is shaped generally like a disk and includes a receiving hole 30 and/or a gas hole 32. In accordance with an embodiment, the receiving hole 30 is a bore having a depth slightly less than the depth of the head 22 and is positioned at the top center of the head 22. The gas hole 32 extends from the bottom of the receiving hole 30 out of the bottom of the head 22.

In general, the nipple 24 is arranged and configured such that, when the recycling button 20 is inserted in the neck 12 of the cylinder 20, the nipple opens the valve 16. In accordance with an embodiment, the nipple 24 includes a shaft 40, a barb 42, a gas tube 44, and a slot 46. The shaft 40 is an elongated piece of material, substantially cylindrical in shape, extending from the center of the head 22. The barb 42 is designed to latch or hook the recycling button 20 in the neck 12, and may have, for example, a shape similar to the frustum of a cone. In the embodiment shown in the drawings, the barb 42 is positioned on the end of the shaft 40 opposite the head 22, with the narrow portion of the barb 42 pointing away from the head 22. In this manner, sloped sides are present on the bottom of the barb 42, and substantially straight sides are provided on the backside of the barb. The barb 42 can also be a widened portion of the shaft 40.

The gas tube 44 is a channel, such as a bore, extending from one end of the nipple 24 to the other and provides a fluid connection from the end of the nipple 24 opposite the head 22 to the gas hole 32. Thus, the gas hole 32 in the head 22 and the gas tube 44 in the nipple 24 form a fluid connection from the bottom end of the nipple 24 to the receiving hole 30. If a receiving hole 30 is not included, the gas hole 32 may extend through the head 22.

As described below, when the nipple 24 is inserted into the neck 12 of the propane cylinder 10, the distal end of the nipple engages the valve core 18, opening the valve 16. Because the positions of the valve core 18 and the gas tube 44 are both centered in the neck 12, it is possible that the top of the valve core may partially or fully prevent flow of gasses from the propane cylinder into the nipple 24. Thus, in accordance with an embodiment, a bypass conduit may be provided to ensure appropriate flow. In the embodiment shown in FIG. 3, this bypass conduit is provided by the slot 46. The slot 46 is a cutout of a portion of the nipple 24. As shown in FIG. 2, the slot 46 runs a portion of the length of the gas tube 44, adjacent and parallel to the gas tube, beginning on the end of the nipple 24 having the barb 42.

FIG. 4 shows another recycling button 120 in accordance with an embodiment. The recycling button 120 includes a head 122 and a nipple 124. Similar to the head 22, the head 122 may include a receiving hole 130 and a gas hole 134. The receiving hole 130 may be configured similarly to the receiving hole 30. As shown in FIG. 5, the gas hole 134 may run through the head 122 at a position adjacent to the receiving hole 130, but removed from a shaft 140 of the recycling button 120.

As shown in FIG. 4, in accordance with an embodiment, the nipple 124 includes a shaft 140, a barb 142, and a slot 148. The shaft 140 may be configured similarly to the shaft 40 and the barb 142 may be similar to the barb 42. As shown in FIG. 5, the slot 148 is a channel, such as a cutout of material, along one side of the nipple 124. This cutout serves to permit gasses to flow past the o-ring 19 when the shaft 140 fits tightly in the o-ring. As shown in FIG. 4, the slot 148 may extend through the barb 142 a portion of the length of the shaft 140, for example a distance sufficient to allow passage of gasses past the o-ring. Gasses that flow past the o-ring may then flow out of the gas hole 134, which is offset from the shaft 140. Instead of or in addition to the gas hole 134, the slot 148 may extend the entire length of the shaft 140 and continue under and around the edges of the head 122 to permit gas flow around the head. Multiple slots, such as the slot 148, may be provided at the o-ring area of the shaft 140 or around the head 122. In general, any type of channel may be provided so as to allow gases escaping from the propane cylinder 10 to pass a barb or a recycling button and o-ring of a propane cylinder 10. In addition, the barb of a recycling button may be configured so that, when the recycling button is inserted into the neck 12, the gasses are able to pass the barb and o-ring.

In order to use the recycling button 20 to release propane from a propane cylinder, such as the propane cylinder 10 shown in FIG. 1, a user inserts the recycling button 20 into the neck 12 until the barb 42 passes and extends below the o-ring retainer 14 and the o-ring 19 of the propane cylinder 10. The barb 42 passes or rolls over the o-ring 19 due to the tapered front edge.

When the recycling button 20 is fully inserted, as shown in FIG. 1, the end of the nipple 24 presses down on the valve core 18, thus opening the valve 16 and allowing propane to be released from the propane cylinder 10. The backside of the barb 42, which is substantially perpendicular to the shaft 40, extends behind the o-ring 19 and resists upward movement of the recycling button 20 from the neck 12, thus securing the recycling button 20 inside the neck 12. In this manner, pressure released from the propane cylinder 10 does not force the recycling button 20 out of the neck 12 and the valve core 18 remains depressed by the nipple 24.

As pressure is released from the propane cylinder 10, propane gas flows through the gas tube 44. The slot 46 allows gas to flow past the valve core 18, which otherwise may block the opening of the gas tube 44. If there is a tight fit between the recycling button 20 and the propane cylinder 10, for example at the juncture of the o-ring 19 and the shaft 24, the gas tube 44 may provide the only path for gasses exiting the propane cylinder 20. Similarly, if the head 22 fits tightly in the neck 12, the gas hole 32 may provide the only exit of gasses past the head. If there is not a tight fit between the recycling button 20 and the propane cylinder 10, propane gas may simply flow around the nipple 24 and the head 22, and thus the gas tube 44 and gas hole 32 may not be needed. In either event, with the recycling button 20 inserted, propane gas continues to be released from the propane cylinder 10 until the pressure inside the propane cylinder 10 equalizes with the pressure outside the propane cylinder 10.

After pressure has been released, the recycling button 20 remains in the propane cylinder 10. If the head 22 is mounted below the top of the neck 12 of the propane cylinder 10, there is not a structure for a user to grasp to remove the recycling button 20. Moreover, the barbed shape of the barb 42 (e.g., in the embodiment shown in the drawings, the flat backside of the barb) makes removal even more difficult. Thus, a recycling button 20, once inserted, is very difficult to remove. Having the recycling button 20 remain in the neck 12 of the propane cylinder 10 provides advantages. For example, with the valve 16 remaining in the open position, gasses may freely flow between the propane cylinder 10 and atmosphere. Because propane is heavier than air, releasing pressure from a propane cylinder may not result in propane being completely discharged from the propane cylinder, especially if the propane cylinder is in an upright position. Keeping the recycling button 20 in the cylinder permits circulation of gasses from the inside of the cylinder to the outside and vice versa, increasing the likelihood that propane will exit the cylinder. Moreover, if conditions change, such as heating of the propane cylinder 10 by the sun, pressure inside the propane cylinder 10 does not build, but instead is free to release.

A user inserts the recycling button 120 into the neck 12 of a propane cylinder 10 in a similar manner to the recycling button 20. When gas is being released from the propane cylinder 10, gas flows past the o-ring 19 via the slot 148 and then exits past the head 122 through the gas hole 134. Alternatively, as described above, one or more slots may be provided for allowing gas to flow around the head 122. As with the recycling button 20, if there is not a tight connection between the recycling button 120 and the propane cylinder 10, propane may additionally flow around the head 122 and/or the shaft 140.

Because the recycling button 20, 120 remains in the neck 12 of the propane cylinder 10, the presence of a fully-inserted recycling button acts as a positive indicator that pressure has been released from the propane cylinder 10. In this manner, a person inspecting the propane cylinder 10 has quick visual feedback that the cylinder is empty.

Recycling buttons, such as the recycling buttons 20, 120 may have additional features or may be configured differently. For example, a recycling button may comprise a threaded portion so a recycling button is inserted by screwing the recycling button onto the external threads of the neck 12 of a propane cylinder 10. In this instance, a barb is not necessary as the recycling button may be held in place by the threads of the recycling button engaging the threads of the neck 12. Other examples of alternate embodiments include varying the size, number, and location of any slots or holes, or fitting a recycling button by friction fit or clips. In addition, a recycling button may be configured for use with other fuel bottles, tanks, or cylinders, for propane or other liquid fuels.

As another alternative, a recycling button may be configured to indicate that pressure has been released from a cylinder, for example, by including a streamer that is released and caused to flap as propane exits a propane cylinder. Recycling buttons, such as the recycling buttons 20, 120 may include bright coloration so that recyclers may quickly and easily identify whether a propane cylinder, such as the propane cylinder 10, has a recycling button installed, and therefore its pressure released.

As described above, a recycling button 20, 120 may be configured to fit fully inside a propane cylinder 10. In this manner, the recycling button 20, 120 may not be removed by an individual after inserted.

In addition, a recycling button, such as the recycling buttons 20, 120, may be configured so that gas exits a propane cylinder at a very slow rate, for instance by having a tight fit between the recycling button and the propane cylinder 10 and having small passageways through which gas may flow. For example, a recycling button may be configured so that a full propane cylinder takes an hour to fully discharge substantially all its propane, thereby reducing the possibility that a dangerous amount of propane is discharged in a short period of time. Configuring a recycling button to have a tight fit between the recycling button and the propane cylinder also reduces the freedom of movement of a recycling button relative to a propane cylinder, thereby making it unlikely that the recycling button has been inserted incorrectly, and/or reducing the possibility that the recycling button may be removed.

Recycling buttons may be molded or formed from a single piece of material, or may comprise a plurality of pieces. For example, a recycling button may be configured so that one piece is inserted into the neck 12 of a propane cylinder 10, but is not held in place until a second piece is inserted. Such recycling buttons could function similarly to rivets currently used for automobile body trim, such as bumpers. Additionally, a recycling button may be configured to fit a variety of valve profiles, for instance, valve profiles conforming to CGA (Compressed Gas Association) 600 guidelines.

A manufacturer or seller of propane cylinders, such as the propane cylinder 10, may include a recycling button, such as the recycling buttons 20, 120, with every propane cylinder manufactured or sold. Instructions how to use the recycling button may be included. Manufacturers or sellers of propane cylinders may provide recyclers or other parties with recycling buttons so that recyclers may use the recycling buttons themselves in order to make sure that the recycling buttons are used correctly. Recycling buttons, such as the recycling buttons 20, 120 may include a structure for attachment to a propane cylinder (not shown), such as a piece of material (e.g., a lanyard) configured to fit over the neck 12 of the propane cylinder 10.

A cap for a propane cylinder may be configured so that the cap acts as a cover for the neck of a propane cylinder, but may be turned around and used as a recycle button when the propane cylinder is ready to be recycled. This could be accomplished, for example, by attaching a cap (not shown) to the head 22, 122 of the recycling buttons 20, 120, respectively. A piece of material may seal any holes until the cap is ready to be used as a recycling button.

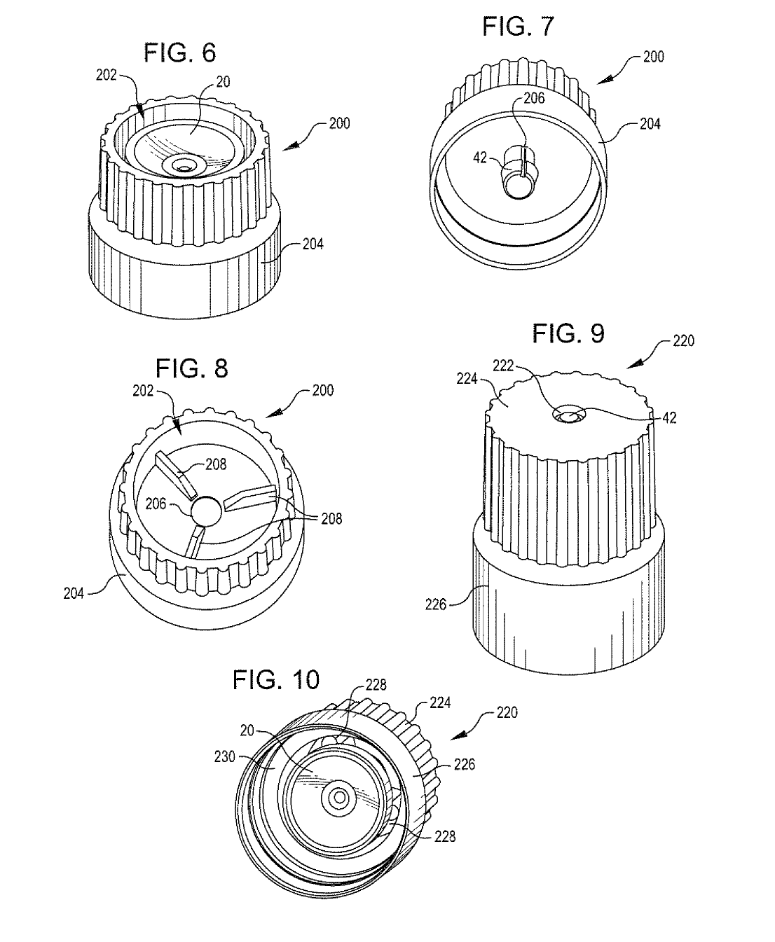

For example, FIG. 6 shows a cap 200 for receiving a recycling button, such as the recycling button 20, in accordance with an embodiment. The cap 200 includes an upper recess 202 mounted above a lower annular flange 204. The lower annular flange 204 is configured to fit on the top and around the perimeter of the neck 12 for the propane cylinder 10, and may include threads for threading onto the neck.

As can be seen in FIG. 8, the upper recess 202 includes a central opening 206. In an embodiment, reinforcing ribs 208 extend from a bottom of the upper recess 202 upward toward a top of the cap 200, a portion of the distance between the bottom of the upper recess and the top of the cap. In the embodiment shown in the drawings, the reinforcing ribs 208 extend radially with respect to the central opening 206, but may be arranged in a different manner.

For the cap 200 shown in FIGS. 6-8, a recycling button, such as the recycling button 20, is mounted in the upper recess 202, with the head 22 at the top of the cap 200 and the nipple 24 pointed downward. The nipple 24 extends into the central opening 206, and the bottom of the head 22 seats against the top edge of the reinforcing ribs 208.

When the cap 200 is installed on a propane bottle, the lower annular flange 204 fits around the threads of the neck 12, either by a friction fit or by threading onto the threads. The barb 42 may extend into the neck 12 of the propane cylinder 10, but does not extend far enough into the cylinder to engage the o-ring 19.

In the embodiment shown in the drawings, the head 22 is recessed within the upper recess 202. If desired, in an alternate embodiment, the head 22 may be exposed. However, in the embodiment shown in the drawings, the walls of the outer recess serve as a structure to prevent accidental insertion of the recycling button into the neck 12 upon dropping of the propane cylinder 10 onto the neck 12. In addition, the reinforcing ribs 208 act as an additional structural barrier to accidental insertion of the recycling button.

Having the recycling button 20 installed in the cap 200 provides a convenient location for storage of the recycling button, allowing a user to maintain the recycling button until needed. The recycling button 20 may be easily removed from the cap 200, for example by pressing upward on the nipple 24. If desired, the nipple 24 may be friction fit into the central opening 206, and light pressure on the bottom of the nipple may result in removal of the recycling button 20. Alternatively, a ridge or other structure may engage the barb 42 so as to maintain the recycling button 20 in the cap 200 until it is pushed out by pushing the bottom of the nipple 24, as described above.

FIGS. 9-11 show an alternative embodiment of a cap 220 in which a recycling button is stored in an upside-down position. Storing the recycling button in the upside-down position removes the possibility of accidental insertion of the recycling button by dropping of the propane cylinder.

In the embodiment shown in FIGS. 9-11, the cap 220 includes an upper opening 222. An upper casing 224 extends above a lower annular flange 226. The lower annular flange 226, like the lower annular flange 204, is designed to fit on the neck 12 of a propane cylinder 10.

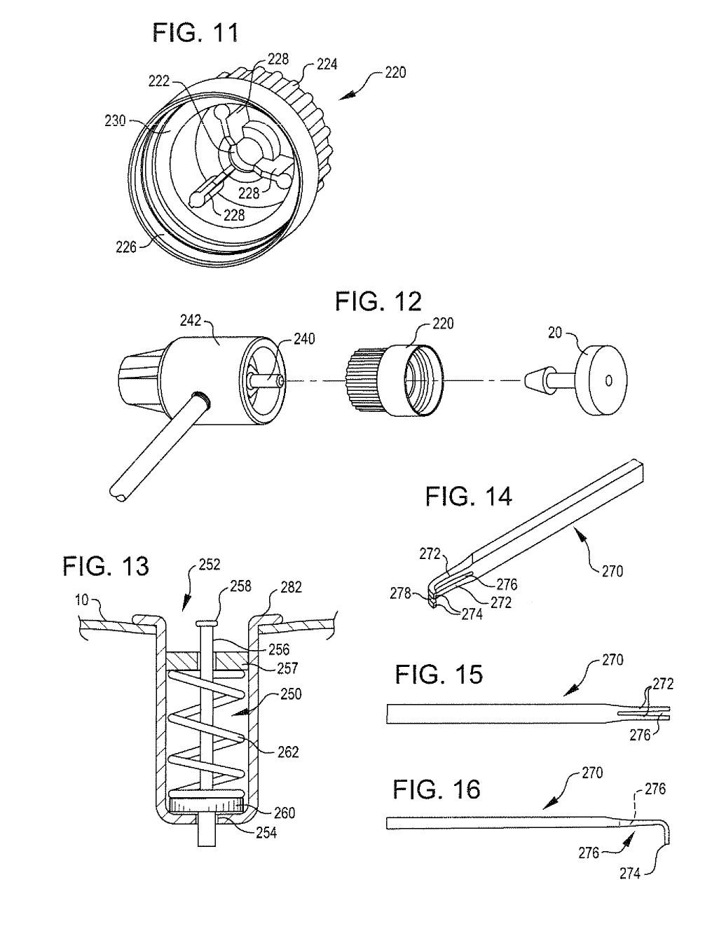

As can be seen in FIG. 11, reinforcing ribs 228, similar to the reinforcing ribs 208, extend about the upper opening 222, and into the upper casing 224 of the cap 220. The reinforcing ribs 228 are preferably shaped and configured so that a recycling button 20 may be installed in the cap 220 with the bottom portion of the head 22 of the recycling button seated against the lower edges of the reinforcing ribs 228. The bottom edge of the barb 42 is visible through the upper opening 222, as is shown in FIG. 9.

With the recycling button 20 installed in the cap 220, the cap may be placed on a propane cylinder 10, with the head 22 of the recycling button aligning against the top of the neck 12 of the propane cylinder 10. If desired, the head 22 may be positioned so that it extends partially or fully into the neck 12 of the propane cylinder and abuts against the top of the o-ring retainer 14 or other structures within the neck.

If desired, an annular ring 230 (FIG. 10) may be provided on the inside of the cap 220 for tightly fitting around the head 22 of the recycling button 20. This annular ring 230 makes grasping of the head 22 difficult, preventing accidental removal of the recycling button.

In an embodiment, as shown in FIG. 12, the recycling button 20 is removed from the cap 220 by inserting a probe 240, such as the typical probe as found on a gas regulator 242 or any gas regulator or appliance designed for use with the propane cylinders, known as a CGA#600 cylinder valve connection, into the upper opening 222 of the cap 220. Inserting the probe 240 in this manner causes pressure on the distal end of the nipple 24, pushing the recycling button 20 out of the cap 220. In this manner, the recycling button 20 may be removed from the cap 220. Requiring the probe 240 for removal aids in safety, and aids in preventing malicious or inadvertent use of a recycling button.

In accordance with an embodiment, a tool may be provided to aid in installation and/or use of a recycling button. For example, FIG. 1 shows a recycling tool 150 in accordance with an embodiment. As shown in the figure, the recycling tool 150 may be used in connection with a recycling button, such as the recycling buttons 20, 120, to release propane gas from a propane cylinder. The recycling tool 150 comprises an indicator portion 152, a pressure release portion 154 and a casing 158, all of which may share common parts.

In accordance with an embodiment, the indicator portion 152 includes a diaphragm 160, an indicator 162, an outlet port 164, a perforated cover 166, and a cap 168. The diaphragm 160 has the shape of a disk and comprises elastic material, such as rubber. As shown in FIG. 1, the outlet port 164 is a small hole running through the side of the indicator portion 152. As further described below, the outlet port 164 provides an exit for gas that is released from the propane cylinder 10, the gas flowing from the outlet port 164 through the perforated cover 166 to the atmosphere. The outlet port 164 may be configured to be sufficiently small in order to restrict the flow of gas through the outlet port 164 so that any pressure released through the outlet port 164, as described below, will be released slowly. The indicator 162 may have a shape similar to a nail, with an elongated portion extending from the center of a disk. The perforated cover 166 may be configured with a plurality of holes to cause any gas being released through the outlet port 164 to be released through the plurality of holes instead of from one single hole. The cap 168 may be in the shape of a bowl and may include a hole 169 through which the indicator 162 may move.

The pressure release portion 154 includes a gasket 170, a washer 172, a probe 174, and a retaining clip 176. The gasket 170 may be an annular ring made from a flexible material, such as rubber or other materials. The washer 172 may be made from a rigid material, such as steel, or may be made from other materials. The probe 174 may comprise the union of four cylinders having various diameters, all aligned to share a common axis along which a channel 180 extends. The channel 180 extends the complete length of the probe 174. The probe 174 may include a ramming portion 182 which may have a diameter sufficiently close to the head of the recycling button 20, 120, in order to aid the probe 174 in pushing the recycling button into the neck 12 of a propane cylinder 10 to release propane from the propane cylinder 10.

As shown in FIG. 1, a retaining clip 176 or other mechanism may fit in a groove of the probe 174, thereby securing the probe 174 to the recycling tool 150. In particular, the ramming portion 182 and the retaining clip 176 are located on opposite ends of a hole 183 running through the gasket 170, the washer 172, and the casing 158, with the ramming portion 182 and the retaining clip 176 both having a diameter larger than the diameter of the hole 183. Because of this arrangement, the ramming portion 182 prevents the probe 174 from moving substantially upward and the retaining clip prevents the probe 174 from moving substantially downward; therefore, the probe 174 is secured in place in the recycling tool 150.

The casing 158 may be substantially in the shape of a cylinder and is configured to retain the cap 168 on one end and configured for attachment to a propane cylinder, such as the propane cylinder 10, on the other end. The casing 158 may be made from metal, plastic, or other materials. As shown in FIG. 1, the casing may be threaded so that the recycling tool 150 may be screwed onto the neck 12 of the propane cylinder 10. The casing may be configured otherwise, for example, by not having threads so that a user may easily remove the recycling tool 150.

A user uses the recycling tool 150 by first either inserting the probe 174 into the receiving hole 30 of the recycling button 20, 120 or by inserting the recycling button 20, 120 partially into the neck 12. Then the user places the recycling tool 150 onto the neck 12, for example, by screwing the recycling tool 150 onto the neck 12. As the recycling tool 150 is being placed onto the neck 12, the ramming portion 182 of the probe 174 forces the recycling button 20, 120 into the neck 12 of the propane cylinder 10, as described above.

When the recycling button 20, 120 is inserted fully into the neck by using the recycling tool 150, propane flows from the propane cylinder 10 through or around the recycling button 20, 120 (as described above) and is released into the recycling tool 150. The pressure inside the recycling tool 150 causes the diaphragm 160 to expand. Expansion of the diaphragm 160 causes the indicator 162 to protrude through the hole 169 of the cap 168. When all pressure has been released from the propane cylinder 10, the elasticity of the diaphragm 160 causes the diaphragm 160 to return to its original state thereby pulling the indicator 162 back so that the indicator 162 no longer protrudes through the hole 169 of the cap 168. A spring or other device(not shown) may be included around the indicator 162 between the diaphragm 160 and the cap 168. The spring or other device pushes the diaphragm 160 downward so that the indicator 162 does not protrude through the hole 169 unless the pressure of gas inside the tool 150 is enough to counteract the force of the spring or other device so that the indicator protrudes through the hole 169. In this manner, the spring or other device provides protection against the indicator 162 protruding through the hole 169 when there is no pressure inside the tool 150, thereby falsely indicating pressure inside the tool 150.

Therefore, by using a recycling tool 150, a user can know whether there is pressurized propane inside the propane cylinder 10 by looking at whether the indicator 162 is protruding through the cap 168. In particular, if the indicator 162 is protruding through the cap 168, then there is still pressure inside the propane cylinder 10, but if the indicator 162 is not protruding, then all the pressure has been released from the propane cylinder 10.

After the indicator 162 is no longer protruding, the recycling tool 150 may be removed, leaving the recycling button 20 attached to the propane cylinder 10. As described above, the presence of the recycling button 20 acts as positive visual feedback that the propane cylinder 10 is empty. The recycling tool 150 may then be used to install a recycling button 20, 120 onto another cylinder.

Pressure inside the recycling tool 150 caused by the release of propane from a propane cylinder 10 is released through the outlet port 164. The perforated cover 166 causes the propane gas to be released in a dispersed manner instead of having a stream of propane being released from one location.

Recycling tools may be configured to work with different recycling buttons. For example, the recycling tool 150 may have the probe 174 configured differently in order to channel propane gas coming from the gas hole 134 of the recycling button 120 to the indicator portion 152. This could be done by creating a hole in the probe 174 to line up with the gas hole 134. The receiving hole 130 and the probe 174 may be configured with a triangular or other shape so that the recycling button 120 can only work in the recycling tool 150 in a finite number of configurations, each configuration having the ability to channel propane gas into the indicator portion 152. Recycling tools may additionally be configured for other configurations of recycling buttons and may be configured to work with a variety of recycling buttons.

Recycling tools, such as the recycling tool 150 described above, may be sold or otherwise provided to consumers or recyclers or other parties.

FIG. 13 shows a pressure-release valve 250 of the propane cylinder 10. The pressure-release valve 250 is located in an opening 252 of the propane cylinder 10, which is a cylindrical depression in the propane cylinder 10, having a flat bottom through which a hole 254 extends. A plunger 256, which is an elongate rod of metal, extends from the interior of the propane cylinder 10, through the hole 254, and through a hole in a bearing 257 located near, extending across, and rigidly attached to the top of the opening 252. The plunger 256 terminates in a head 256 opposite the end of the plunger 256 extending into the interior of the propane cylinder 10 through the hole 254, the head 258 being a widened portion of the plunger 256.

A valve seat 260 formed from soft material, such as rubber, is rigidly attached to the plunger 256 so that the valve seat 260 extends around the plunger 256 above and adjacent to the hole 254. The valve seat 260 is forced downward by a spring 262 extending between and pushing apart the bearing 257 and the valve seat 260. Typically, the pressure-release valve 250 opens when the internal pressure of the propane cylinder 10 exceeds a certain amount. Specifically, when the internal pressure of the propane in the propane cylinder 10 is enough to overcome the force of the spring 262 on the valve seat 260, propane escaping from the propane cylinder 10 pushes the valve seat 260 upwards, thereby exposing the hole 254 through which the contents can escape. Propane escaping through the hole 254 exits the propane cylinder through the center of the bearing 257 through which the plunger 256 extends or though other holes in the bearing 257.

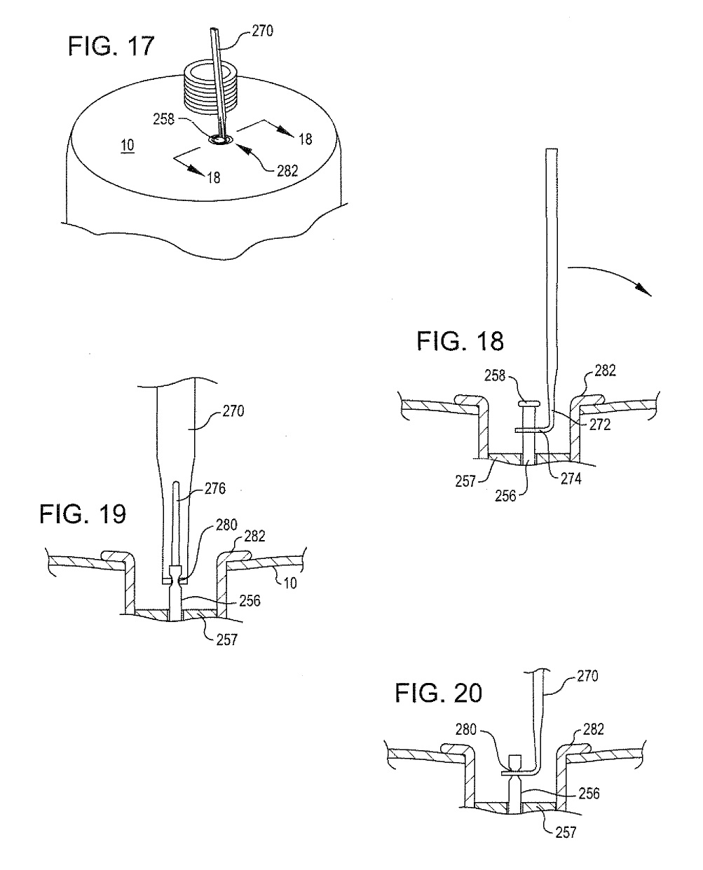

In addition to the methods of releasing pressurized contents of a propane cylinder described above, pressurized contents of the propane cylinder 10 can also be released via the pressure-release valve 250 by using a tool 270, shown in FIG. 14. In an embodiment, the tool 270 is a bar of metal or other rigid material with two parallel prongs 272 extending from an end of the tool 270, as shown in FIG. 15. Turning to FIG. 16, both of the prongs 272, in an embodiment, are bent approximately 90 degrees in the same direction so as to form two parallel feet 274 extending from an end of the tool 270. The feet 274 and the prongs 272 are dimensioned so that the feet may be inserted into the opening 252 with the prongs 272 oriented upward, as shown in FIGS. 17 and 18.

Each of the prongs 272 are spaced one from another so that a first slot 276 extends between the prongs 272 along the length of the tool 270 perpendicular to and continuous with a second slot 278 extending between the feet 274. In an embodiment, the first slot 276 and second slot 278 are wider than the plunger 256 but narrower than the head 258 so that the tool 270 can be positioned with the plunger 256 in the second slot 278 but so that the head 258 cannot pass through the second slot 278. In another embodiment, tool 270 is configured such that the first slot 276 and second slot 278 are wider than a swedge 280 in the plunger 256 but so that the portion of the plunger 256 adjacent and higher than the swedge 280 is wider than the first slot 276 and second slot 278, as shown in FIGS. 19-20. In general, the tool 270 is configured such that a portion of the plunger 256 can be placed in either the first slot 276 or second slot 278 such that a structure on the plunger 256 prevents the plunger 256 from passing through either the first slot 276 or second slot 278 as the tool is moved upward away from the hole 254.

In accordance with an embodiment, pressurized contents of the propane cylinder 10 are released by pulling the plunger 256 upward using the tool 270. In particular, the tool 270 is inserted into the opening 252, as shown in FIG. 17, so that the plunger extends through the second slot 278, as shown in FIG. 18. With the plunger 256 extending through the second slot 278, the tool 270 is rotated such that the end of the tool opposite the feet 274 moves rotationally the same direction as that in which the feet 274 extend from the prongs 272, which, in FIG. 18, is demonstrated by the clockwise pointing arrow.

Rotating the tool 270 in this manner causes the tool to engage an upper edge 282 of the opening 252 which acts as a fulcrum for the tool 270 so that rotation of the tool 270 causes the feet 274 or the prongs 272 to pull upward on the head 258 or swedge 280 of the plunger 256, thereby pulling the valve seat 260 away from the hole 254, allowing the pressurized contents of the propane cylinder 10 to escape through the hole 254.

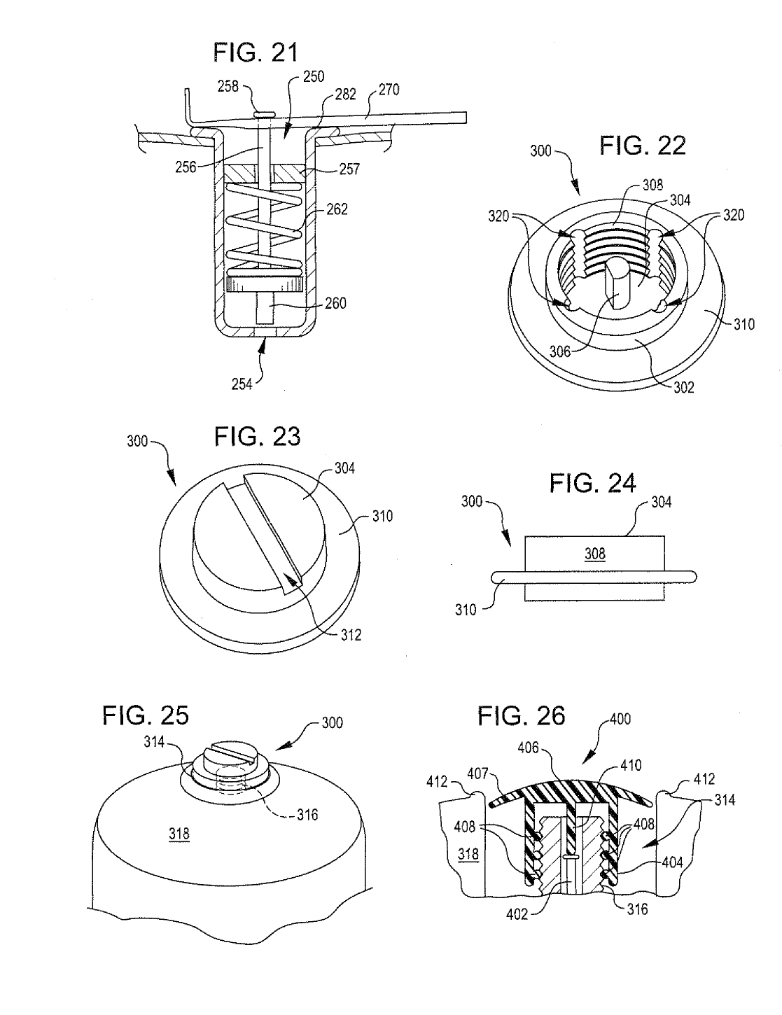

In an embodiment, the tool 270 is configured so that a person does not need to maintain force on the tool 270 so as to counteract the force of the spring 262 pushing the valve seat 260 toward the hole 254 in order to keep the valve 250 open while the pressurized contents are escaping. Specifically, the plunger 256 is pulled upward by the tool 270 so that the head 258 or swedge 280 are above the upper edge 282 of the opening. As shown in FIG. 21, with the head 258 or swedge 280 above the upper edge 282 of the opening and the plunger 256 extending through either the first slot 276 or second slot 278, the tool 270 is maneuvered so that the plunger 256 extends through the first slot 276 and the tool 270 extends horizontally across the opening 252, engaging the upper edge 282 of the opening 252. In this manner, the prongs 272 engage the head 258 or swedge 280, preventing the plunger 256 from moving downward into the opening 252 so as to close the valve 250. When the pressurized contents of the propane cylinder 10 have emptied, the tool 270 can be left attached to the propane cylinder so as to keep the pressure-release valve 250 open and to provide an indication that the propane cylinder is empty, or the tool 270 can be maneuvered so that the plunger 256 passes through the first slot 276 and second slot 278, so as to free the plunger 256 from the tool 270.

FIG. 22 shows a recycling button 300 for use with a butane cylinder containing pressurized butane, although the recycling button 300 may be configured for use with a propane cylinder, or other container containing pressurized contents. In an embodiment, the recycling button 300 comprises a hollow cylinder 302 capped on one end by a disk 304. In an embodiment, the recycling button 300 is formed completely from brass or another metal, although other materials, such as plastic, can be used. As shown in the drawings, the disk 304 completely covers the end of the cylinder 302, although the disk 304 can only partially cover the end of the cylinder 302, and need not have a circular geometric form.

In an embodiment, a rigid shaft 306 extends from the disk 304 toward the interior of the cylinder 302, through a central axis of the cylinder 302, extending approximately the full length of the cylinder 302. In an embodiment, the shaft 306 has a flat side extending the length of the shaft 306, the dimensions of which determine the rate at which pressurized gasses exit a butane cylinder, as described more fully below. A thread 308 extends helically around the interior of the cylinder 302 in a manner matching a thread extending around an exterior neck of a butane cylinder so that the recycling button 300 may be screwed onto the neck in a cap-like manner.

Referring to FIG. 23, the recycling button 300, in an embodiment, includes a flange 310 extending perpendicularly around the exterior cylindrical wall of the cylinder 302. As shown in FIG. 24, the flange 310 extends around the cylinder 302 at a location approximately two thirds of the distance from the disk 304 to the opposite end of the cylinder 302, although the flange 310 can extend around the cylinder 302 at a different location. As shown in FIG. 25, the flange 310 has an outer diameter slightly less than the inner diameter of an opening 314 surrounding a neck 316 of a butane cylinder 318.

Looking to FIG. 23, the recycling button can include a structure for facilitating screwing the recycling button onto a butane cylinder. In an embodiment, the structure is a screwdriver slot 312 extending across an outer surface of the disk 304 which allows a person to use a screwdriver to rotate the recycling button 300 about a central axis. The screwdriver slot 312 can also be configured to allow a person to use a coin to rotate the recycling button 300. In an alternate embodiment, the structure is a hexagonally shaped exterior to the cylinder 302 so that a user may rotate the recycling button about a central axis using a corresponding wrench or pliers. The structure can also be a structure facilitating a hand grip on the recycling button 300 so that a person may rotate the recycling button 300 by hand. In general, any structure or combination of structures facilitating rotation of the recycling button 300 by hand or with the help of a tool can be used.

Referring back to FIG. 22, in an embodiment, the recycling button 300 includes a plurality of channels 320 extending from the disk 304 to the end of the cylinder 302 opposite the disk 304. Each channel interrupts the thread 308 so as to cause a series of periodic discontinuities in the thread 308, thereby providing a direct fluid connection from the interior of the cylinder 302 to the atmosphere. Additionally, each channel extends partially into the interior cylindrical wall of the cylinder 302.

As noted above, the recycling button 300 can be screwed onto the neck 316 of the butane bottle 318 by mating the thread 308 of the recycling button 300 to a thread of the neck 316. As the recycling button 300 is screwed onto the neck 316, the shaft 306 engages a valve core inside the neck of the butane cylinder 318, which operates similarly to the valve core 18 of the propane cylinder 10, described above, and forces the valve core of the butane cylinder 318 downward, thereby opening a valve in the butane cylinder 318.

With the valve of the butane cylinder 318 open, pressurized butane is allowed to escape from the interior of the butane cylinder 318 into the neck of the butane cylinder 318. In an embodiment, butane passes out of the neck 316 at a rate determined by the dimension of the flat side of the shaft 306 compared to the dimension of a hole in the neck 316 through which the shaft 306 protrudes. From the neck, butane passes the thread 308 via the channels 320 until exiting around the end of the cylinder 302 opposite the disk 304, thereby passing from the neck 316 directly to the atmosphere. With the inclusion of the flange 310, the escaping butane exits directly into the atmosphere by flowing around the flange 310 in a dissipated manner.

To remove the recycling button 300 from the butane cylinder 318, the recycling button 300 is simply unscrewed from the neck 316 by rotating the recycling button 300 counter clockwise. However, as with the recycling buttons listed above for use with the propane cylinders, the recycling button 300 for use with butane cylinders can be left attached to a butane cylinder to ensure that the valve remains open and to provide a visual indicator that the butane cylinder has been purged of butane.

Other configurations of the recycling button 300 are also possible. For instance, the various structures of the recycling button 300 can be easily modified for use with a propane cylinder or other similarly-configured container containing pressurized contents. As another example, in addition to or as an alternative to the channels 320, holes extending through the disk 304 can be included so that butane escapes through the holes. In general, any structure that allows attachment to a butane canister, and release of gas to the atmosphere may serve this function.

FIG. 26 shows an alternate embodiment of a recycling button 400 for the butane cylinder 318 or any similarly configured container containing pressurized contents, in accordance with an embodiment. As shown in the drawing, the butane cylinder 318 contains a valve core 402, which opens a valve to release the contents of the butane cylinder 318 when the valve core 402 is pushed downward.

In an embodiment, the recycling button 400 comprises a hollow cylinder 404 capped by a dome 406. In an embodiment, the dome 406 extends past an exterior cylindrical wall of the cylinder 404, thereby forming a downward sloping flange 407 extending around the cylinder 404. One or more beads 408 extend around an interior surface of the cylinder 404. In an embodiment, the beads 408 are rings of material protruding from an inner surface the cylinder 404. Channels (not shown), such as the channels 320 described above, can be included so as to create discontinuities (not shown) in the beads 408.

A shaft 410, configured similarly to the shaft 306 above, extends inwardly from a center portion of the dome 406, approximately parallel to the cylindrical wall of the cylinder 404.

The recycling button 400 functions similarly to the recycling button 300, described above. In an embodiment, the recycling button 400 is pushed onto the neck 316 with the shaft 410 oriented towards the interior of the butane cylinder 318. The beads 408 engage outer threads of the neck 316 so as to secure the recycling button 400 in place on the neck 316 and to prevent the recycling button from coming off the neck 316. To this end, the beads 408 may be formed as barbs to prevent retraction of the recycling button after installed. With the recycling button 408 inserted fully onto the neck 316, the flange 407 extends below an upper edge 412 of the opening 314 of the butane cylinder 318. In an embodiment, the flange 407 extends approximately to an inner wall of the opening 314, leaving a small gap between the flange 407 and the inner wall of the opening 314. In this manner, when the recycling button 400 is attached to the neck 316, no structure is exposed to allow a person to easily remove the recycling button 400 from the butane cylinder 318. Thus, the recycling button 400 remains attached to the butane cylinder 318 so as to provide an indicator that the butane cylinder 318 has been emptied and can be safely recycled.

As the recycling button 400 is pushed on the neck 316, the shaft 410 engages a top portion of the valve core 402 and pushes the valve core 402 downward, thereby opening the valve of the butane cylinder 318. In an embodiment, the beads are positioned on the cylinder 404 so that, as the recycling button 400 is pushed onto the neck, the shaft 410 begins to press the valve core 402 downward to open the valve before any of the beads 408 engage the threaded portion of the neck 316, although the beads 408 can be positioned otherwise. In this manner, a user may retract the recycling button 400 after beginning the release of butane from the butane cylinder 318, but before the beads 408 secure the recycling button 408 onto the neck.

With the recycling button 400 inserted onto the neck 316 of the butane cylinder 318, butane exits the neck 316 as determined by the dimensions of the shaft 410. Butane then passes the beads 408 via the discontinuities in the beads 408, and then into the atmosphere through the small gap. In an alternate embodiment, holes are provided through the disk 406 to allow butane to escape through the disk 406.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A recycling button for releasing pressurized contents of a container having a neck inside of which is a valve that opens when a valve core of the valve is forced inward, comprising:
a shaft having a first end and a second end, the shaft for inserting into the neck with the first end oriented toward an interior of the bottle so as to force the valve core inward thereby opening the valve; and
a barb extending around at least a portion of the first end, the barb configured to engage a structure in the neck so as to resist retraction of the shaft from the neck.

2. The recycling button of claim 1, further comprising a head located on the second end of the shaft, the head configured to provide a surface against which to push the shaft into the neck, the surface being wider than the width of the shaft at the second end.

3. The recycling button of claim 2, further comprising a hole extending through the head so as to fluidly connect the interior of the neck with an exterior of the neck when the first end is inserted into the neck.

4. The recycling button of claim 3, further comprising a channel extending from the first end past the barb, the channel in fluid communication with the hole.

5. The recycling button of claim 2, wherein the head is configured to fit inside the neck when the shaft is inserted into the neck.

6. The recycling button of claim 1, further comprising a channel extending from the first end past the barb.

7. A cap removably secured to the recycling button of claim 1, the cap configured for simultaneously selectively covering a portion of the neck and storing the recycling button.

8. A cylinder of pressurized propane attached to the recycling button of claim 1.

9. A tool for releasing pressurized contents of a container having a neck inside of which is a valve that opens when a valve core of the valve is forced inward, comprising:
a recycling button, comprising:
a shaft having a first end and a second end, the shaft for inserting into the neck with the first end oriented toward an interior of the bottle so as to force the valve core inward thereby opening the valve; and
a barb extending around at least a portion of the first end, the barb configured to engage a structure in the neck so as to resist retraction of the shaft from the neck; and
a cap configured to selectively cover the neck, the cap comprising:
a cylinder closed on one end by a disk, the cylinder configured to selectively cover the neck such that the disk covers an opening of the neck;
a hole extending through the center of the disk, the hole configured to receive the first end of the shaft; and
a structure for engaging the recycling button so as to removably store the recycling button with the first end of the shaft received by the hole.

10. The tool of claim 9, wherein the cap is configured to store the recycling button in an interior of the cap when the cap covers the neck.

11. The tool of claim 10, wherein the first end does not protrude beyond an outer edge of the hole when the recycling button is stored in the interior of the cap.

12. The tool of claim 9, wherein the interior of the cylinder has a thread corresponding to an exterior thread of the neck so that the cap may be secured to the neck by screwing the cap onto the neck.

13. The tool of claim 12, wherein the cap is configured to engage the recycling button so as to push the recycling button into the neck with the first end oriented toward the interior of the bottle as the cap is screwed onto the neck.

14. The tool of claim 9, further comprising a plurality of ribs extending from an interior surface of the cap, the ribs for engaging a lateral surface of the shaft when the first end of the shaft is received by the hole.

15. A cylinder of pressurized propane attached to the cap of claim 9.

16. A recycling button for releasing pressurized contents of a container having a neck inside of which is a valve that opens when a valve core of the valve is forced inward, the neck including exterior thread extending around an outer surface, comprising:
a structure for attaching to the exterior thread;
a protrusion for engaging the valve core and pressing the valve core inward when the structure is attached to the external thread; and
a passageway providing a direct fluid connection between the neck and the atmosphere when the structure is attached to the neck.

17. The recycling button of claim 16, wherein the structure comprises:
a cylinder having a cylindrical wall substantially closed by a disk on a first end and having an interior surface, the cylinder having a second end opposite the disk; and
an interior thread extending around the interior surface and corresponding to the exterior thread for attaching the structure to the neck.

18. The recycling button of claim 17, wherein the protrusion is a shaft extending inwardly from a center of the disk.

19. The recycling button of claim 16, further comprising an engagement structure on an exterior surface of the recycle button, the engagement structure configured to engage a tool for attaching the structure to the exterior thread.

20. The recycling button of claim 17, further comprising an engagement structure on an exterior surface of the cylinder, the engagement structure configured to engage a tool for screwing the cylinder onto the neck.

21. The recycling button of claim 16, wherein the passageway comprises a channel extending along and partially through the cylindrical wall from the first end to the second, the channel additionally extending through the thread so as to create a plurality of periodic discontinuities in the thread.

22. The recycling button of claim 16, further comprising a hole extending through the disk between the shaft and the cylindrical wall.

23. The recycling button of claim 16, further comprising a flange extending around an exterior surface of the cylindrical wall.

24. A cylinder of pressurized butane onto which the recycling button of claim 16 is removably attached.

25. A tool for releasing pressurized contents of a container having a pressure relief valve, the pressure relief valve including a plunger inside an opening which opens the pressure relief valve when lifted and which has a head or swedge, comprising:
a bar having two parallel prongs extending from an end of the bar, each prong bent so as to form two parallel feet, the feet configured fit inside the opening; and
a first slot extending through the feet and configured to engage the plunger behind the head or at the swedge;
a second slot extending between the two parallel prongs, continuous with the first slot, and having a width approximately equal to a width of the first slot, the second slot having a length greater than a radius of the opening.

26. The tool of claim 25, wherein the second slot has an end opposite the feet and wherein the width of the bar at the end is larger than a diameter of the opening.

27. A tool for releasing pressurized contents of a container using a recycling button, the container having a neck with a threaded exterior and a valve core inside the neck which causes the release of the pressurized contents through the neck when forced downward by the recycling button, the tool comprising:
a casing having a threaded interior portion corresponding to the threaded exterior of the neck;
an indicator fluidly connected to the casing, the indicator configured to change from a first configuration to a second configuration when pressure inside the casing exceeds atmospheric pressure;
a probe inside the casing, the probe for forcing the recycling button downward to push the valve core downward as the casing is threaded onto the neck so as to release the pressurized contents into the casing; and
a port extending through the casing, the port for releasing the pressurized contents from the casing into the atmosphere.
